(19) United States
(12) Patent Application Publication
(10) Pub. No.: US 2026/0073494 A1
(43) Pub. Date: Mar. 12, 2026

(54) OBJECT CENTERING METHOD AND OBJECT CENTERING DEVICE

(71) Applicant: REALTEK SEMICONDUCTOR CORPORATION, Hsinchu (TW)

(72) Inventors: YAO-JIA KUO, Hsinchu (TW); Wen-Tsung Huang, Hsinchu (TW); Chi-Jung Chen, Hsinchu (TW)

(21) Appl. No.: 19/319,541

(22) Filed: Sep. 4, 2025

(30) Foreign Application Priority Data
Sep. 6, 2024 (TW) 113133979

(51) Int. Cl. G06T 5/80; G06T 3/4007; G06T 7/194; G06T 7/50; G06T 7/73; G06V 40/16

(52) U.S. Cl. CPC G06T 5/80; G06T 3/4007; G06T 7/194; G06T 7/50; G06T 7/73; G06V 40/161; G06T 2207/30201

(57) ABSTRACT

An object centering method is disclosed herein. A processor reads at least command stored in a memory and executes the object centering method. The object centering method includes following steps: performing a foreground object segmentation process according to a depth image and a face image to generate a foreground object image; determining a relation between the foreground object image and a predetermined threshold to generate a determination result; and performing an object centering process to the foreground object image according to the determination result to generate an object centering image, or performing the object centering process to the face image according to the determination result to generate the object centering image.

### BACKGROUND OF THE INVENTION

### 1. Field of the Invention

The present disclosure relates to an object centering method and an object centering device, especially to an object centering method and an object centering device that perform an object centering process to a foreground object image or a face image according to determination results of a foreground object.

### 2. Description of Related Art

In the field of image processing, object centering process technology requires object detection results. For example, face centering technology involves performing face detection to an image and centering the face in the image according to face detection results.

However, due to the wide variety of object types, it is extremely difficult to collect and train data for such complex object types, such that it is hard to cover all object types by using the object detection results. If the object detection results are incorrect, it will affect the performance of the object centering process.

### SUMMARY OF THE INVENTION

In some aspects, an object of the present disclosure is to, but not limited to, provides an object centering method and an object centering device that makes an improvement to the prior art.

An embodiment of an object centering method of the present disclosure, which is performed by a processor reading at least one command of a memory, includes following steps: performing a foreground object segmentation process according to a depth image and a face image to generate a foreground object image; determining a relation between the foreground object image and a predetermined threshold to generate a determination result; and performing an object centering process to the foreground object image according to the determination result to generate an object centering image, or performing the object centering process to the face image according to the determination result to generate the object centering image.

An embodiment of an object centering device of the present disclosure includes a memory and a processor. The memory is configured to store at least one command. The processor is configured to read the at least one command to execute following steps: performing a foreground object segmentation process according to a depth image and a face image to generate a foreground object image; determining a relation between the foreground object image and a predetermined threshold to generate a determination result; and performing an object centering process to the foreground object image according to the determination result to generate an object centering image, or performing the object centering process to the face image according to the determination result to generate the object centering image.

Technical features of some embodiments of the present disclosure make an improvement to the prior art. For example, due to the wide variety of object types, it is extremely difficult to collect and train data for such complex object types, such that it is hard to cover all object types by using the object detection results, which may result in errors in the object detection results. The object centering method and the object centering device of the present disclosure can perform an object centering process to a foreground object image or a face image according to the determination result of the foreground object, thereby addressing the issue that errors in the object detection results affect the object centering process.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of an object centering device of the present disclosure.

FIG. 2 shows an embodiment of a flow diagram of an object centering method of the present disclosure.

FIG. 3 shows an embodiment of a flow diagram of a method for generating a foreground object image of the present disclosure.

FIG. 4 shows an embodiment of an input image of the present disclosure.

FIG. 5 shows an embodiment of an object mask image of a foreground object of the present disclosure.

FIG. 6 shows an embodiment of a flow diagram of a method for bounding box adjustment and image magnification of the present disclosure.

FIG. 7 shows an embodiment of a bounding box adjustment of the present disclosure.

FIG. 8 shows an embodiment of an image magnification of the present disclosure.

FIG. 9 shows an embodiment of a flow diagram of a method for generating a depth image of the present disclosure.

FIG. 10 shows an embodiment of a flow diagram of a method for generating a face image of the present disclosure.

### DETAILED DESCRIPTION OF THE PREFERRED EMBODIMENTS

To address the issue of errors in the object detection results affecting the object centering process, the present disclosure provides an object centering method and an object centering device, which will be explained in detail as shown below.

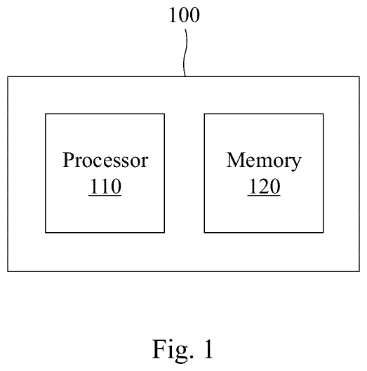

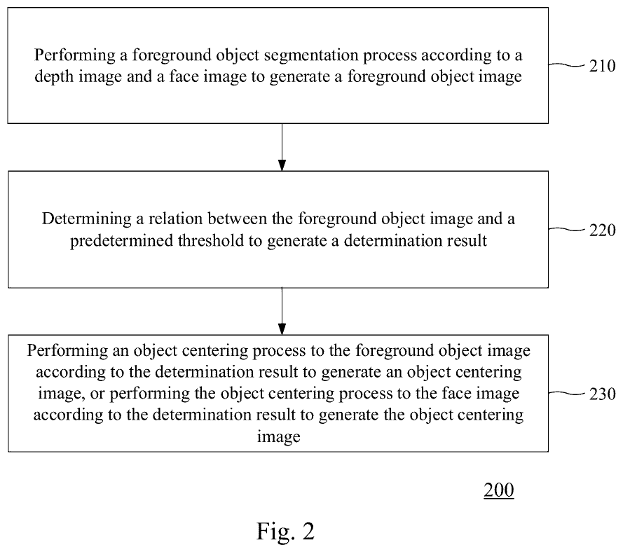

FIG. 1 shows an embodiment of an object centering device 100 of the present disclosure. As shown in the figure, the object centering device 100 includes a processor 110 and a memory 120. The memory 120 is configured to store at least one command. The processor 110 is configured to read the at least one command to execute an object centering process. For facilitating the understanding of operations of the object centering device 100, reference is now made to FIG. 2. FIG. 2 shows an embodiment of a flow diagram of an object centering method 200 of the present disclosure.

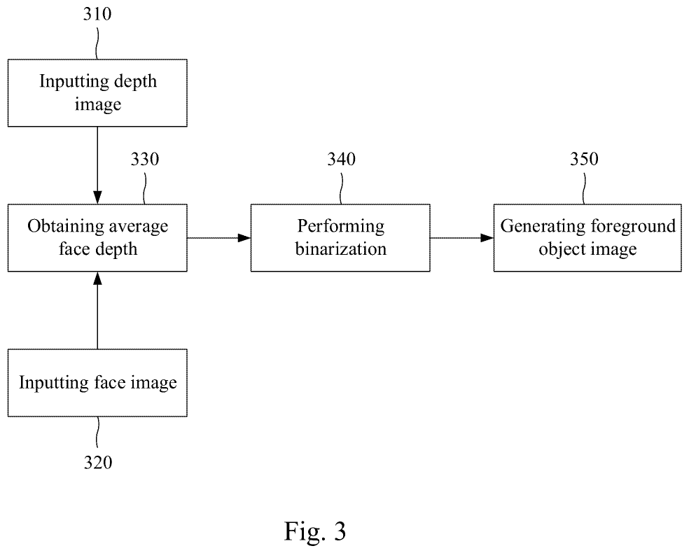

In step 210, performing a foreground object segmentation process according to a depth image and a face image to generate a foreground object image. For example, reference is made to FIG. 3, in step 310, inputting a depth image. In step 320, inputting a face image. Subsequently, in step 330, obtaining an average face depth according to the depth image and the face image. for example, a related formula is as follows:

$${AvgDepth}_{face} = \frac{1}{Area ( {ROI}_{face} )} = {\sum }_{i ∈ {ROI}_{face}} {DepthMap}_{i} \qquad formula 1$$

As shown in formula 1, AvgDepth_{face} is the average face depth, ROI_{face} is the face region of interest (ROI), and DepthMapᵢ is the depth image.

In step 340, performing a binarization according to the average face depth. For example, a related formula is as follows:

$$Mask ( i , j ) = \{ \begin{matrix}255 , & DepthMap ( i , j ) < {AvgDepth}_{face} \\ 0 , & DepthMap ( i , j ) \geq {AvgDepth}_{face}\end{matrix} \qquad formula 2$$

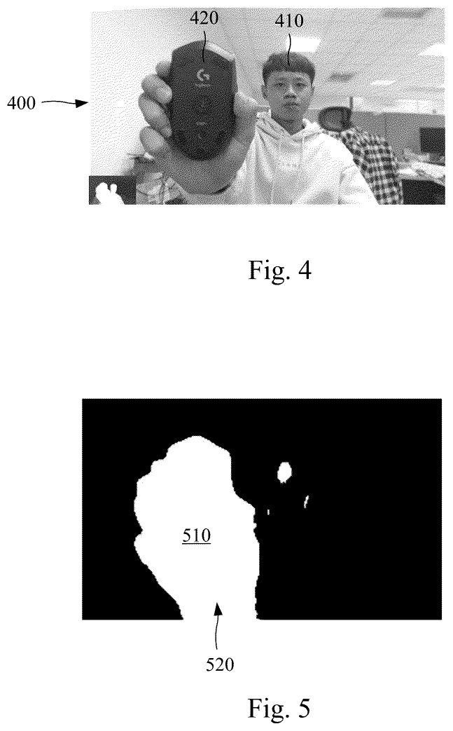

As shown in formula 2, the depth image DepthMap(i, j) ranges from 0 to 255. Formula 2 uses the average face depth AvgDepth_{face} as the threshold to obtain an object mask image Mask(i, j), representing the object closer to the image capturing device than the face. Reference is made to FIG. 4, the input image 400 includes a face 410 and a foreground object 420. Reference is made to FIG. 5, the present disclosure can obtain the object mask image 510, representing the object closer to the image capturing device than the face 410, according to formula 2. The object mask image 510 corresponds to the foreground object 420.

In step 350, generating the foreground object image. For example, the present disclosure may utilize connected component analysis to analyze the object mask image 510 to obtain a bounding box 520. The object within the input image 400, which corresponds to the bounding box 520, is the foreground object 420.

Referring back to FIG. 2, in step 220, determining a relation between the foreground object image and a predetermined threshold to generate a determination result. In step 230, performing an object centering process to the foreground object image according to the determination result to generate an object centering image, or performing the object centering process to the face image according to the determination result to generate the object centering image. For example, the determine formula is as follows:

$${ROI}_{obj} ( i , j ) = \{ \begin{matrix}{ROI}_{fg} , & AreaRatio ( {ROI}_{fg} ) > 0.03 , \\ {ROI}_{face} , & else\end{matrix} \qquad formula 3$$

As shown in formula 3, ROI_{obj}(i, j) is the region of interest (ROI) of the object. If the proportion AreaRatio(ROI_{fg}) of pixels in the foreground object is larger than a predetermined threshold 0.03, the object centering process is performed to the foreground object to generate the object centering image. If the proportion AreaRatio(ROI_{fg}) of pixels in the foreground object is less than the predetermined threshold 0.03, the object centering process is performed to the face to generate a face centering image. However, the present disclosure is not limited to the aforementioned embodiment, which serves merely as an illustrative example of one implementation of the present disclosure. In other embodiments, the predetermined threshold can be set to other suitable values depending on actual requirements.

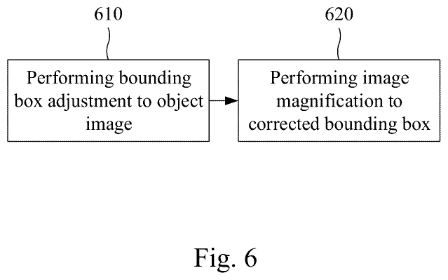

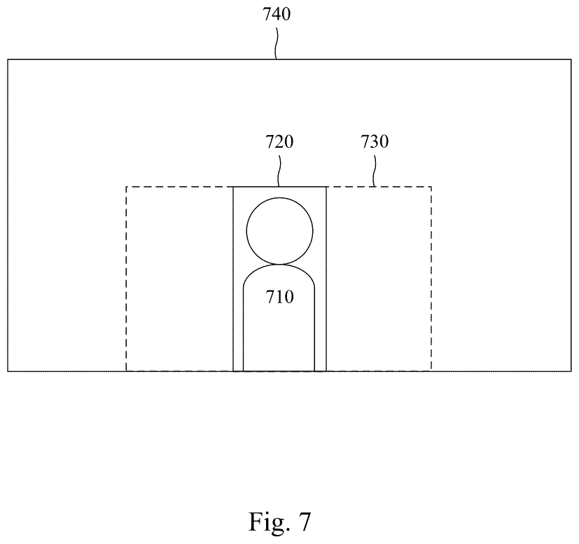

In some embodiments, the steps of performing an object centering process to an object image to generate an object centering image in the present disclosure are described with reference to FIG. 6. In step 610, performing a bounding box adjustment to the object image (e.g., a foreground object image or a face image) to generate a corrected bounding box. For example, referring to FIG. 7, the present disclosure obtains an object image (e.g., object bounding box) 720 according to the object 710. Since the aspect ratio of the object image 720 does not match that of the input image 740, a bounding box adjustment is required for the object image 720 to generate the corrected bounding box 730. The bounding box adjustment ensures that if the corrected bounding box 730 is magnified in subsequent steps, the aspect ratio of the corrected bounding box 730 will match that of the input image 740 or the subsequent output image.

$${ROI}_{r evised} \cdot W = \{ \begin{matrix}{ROI}_{obj} \cdot H \times \frac{ImgW}{ImgH} , & if \frac{ImgH}{ImgW} < \frac{{ROI}_{obj} \cdot H}{{ROI}_{obj} \cdot W} \\ {ROI}_{obj} \cdot W , & else\end{matrix} \qquad formula 4$$

$${ROI}_{r evised} \cdot H = \{ \begin{matrix}{ROI}_{obj} \cdot H , & if \frac{ImgH}{ImgW} < \frac{{ROI}_{obj} \cdot H}{{ROI}_{obj} \cdot W} \\ {ROI}_{obj} \cdot W \times \frac{ImgH}{ImgW} , & else\end{matrix} \qquad formula 5$$

$${ROI}_{r evised} \cdot X = ( {ROI}_{obj} \cdot X + \frac{{ROI}_{obj} \cdot W}{2} ) - \frac{{ROI}_{revised} \cdot W}{2} \qquad formula 6$$

$${ROI}_{r evised} \cdot Y = ( {ROI}_{obj} \cdot Y + \frac{{ROI}_{obj} \cdot H}{2} ) - \frac{{ROI}_{revised} \cdot H}{2} \qquad formula 7$$

Referring to formula 4, ROI_{revised}.W is the revised width, which is obtained according to height ROI_{obj}.H or width ROI_{obj}.W of an original object. Referring to formula 5, ROI_{revised}.H is the revised height, which is obtained according to height ROI_{obj}.H or width ROI_{obj}.W of the original object. Referring to formula 6, ROI_{revised}.X is the revised x coordinate, which is obtained according to x coordinate ROI_{obj}.X of the original object, width ROI_{obj}.W of the original object, and the revised width ROI_{revised}.W. Referring to formula 7, ROI_{revised}.Y is the revised y coordinate, which is obtained according to y coordinate ROI_{obj}.Y of the original object, height ROI_{obj}.H of the original object, and the revised height ROI_{revised}.H.

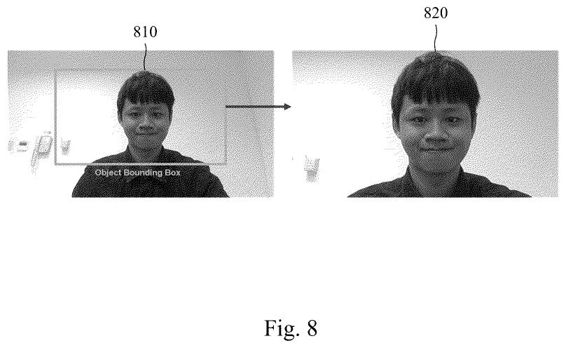

In step 620, performing an image magnification to the corrected bounding box to generate an object centering image. For example, referring to FIG. 8, the present disclosure performs the image magnification to the corrected bounding box 810 to generate the object centering image 820. In some embodiments, the present disclosure may use bilinear interpolation to perform the image magnification.

In some embodiments, during the object centering process, directly magnifying the object may affect the user experience. Therefore, the present disclosure provides a progressive centering method. The formula for progressive centering is as follows:

$${ROI}_{cur} = ( {ROI}_{revised} - {ROI}_{prev} ) \times K \qquad formula 8$$

As shown in formula 8, ROI_{cur} is the object centering image, ROI_{revised} is the corrected bounding box, ROIₚᵣₑᵥ is the previous bounding box, K is the progressive parameter, and K can be adjusted by the user. The present disclosure may utilize formula 8 to perform the object centering process progressively in order to avoid affecting the user experience.

In some embodiments, the present disclosure can generate the object depth-of-field image according to the object centering image and the depth image. For example, a related formula is as follows:

$${Img}_{DOF} = BoxFilter ( {Img}_{framing} ) \qquad formula 9$$

$${Img}_{Out} = {Img}_{DOF} \times DepthMap + {Img}_{framing} \times ( 255 - DepthMap ) \qquad formula 10$$

As shown in formula 9, the present disclosure performs a filtering process to the object centering image Img_{framing} to generate the depth-of-field image Img_{DOF}. As shown in formula 10, the present disclosure generates the object depth-of-field image Img_{Out} according to the depth-of-field image Img_{DOF}, the depth image DepthMap, and the object centering image Img_{framing}.

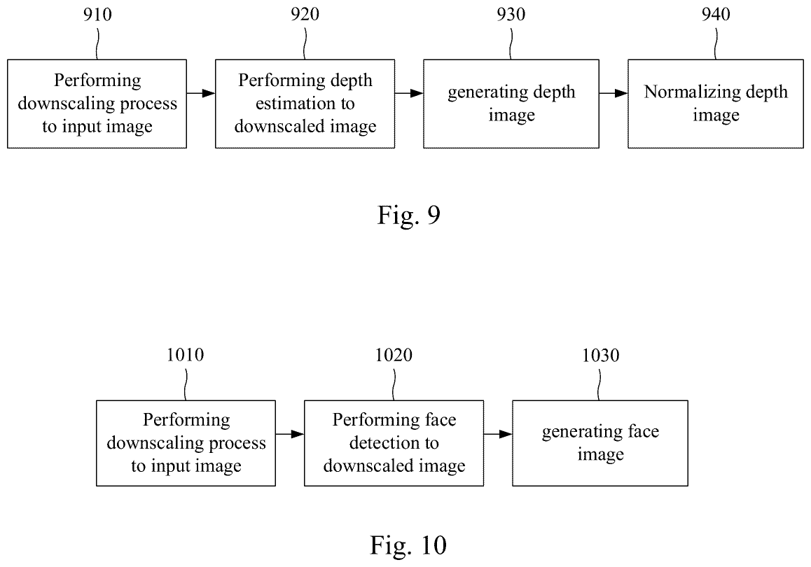

Referring to FIG. 4 and FIG. 9, in step 910, performing a downscaling process to an input image 400 to generate a downscaled image. For example, the present disclosure may use bilinear interpolation to downscale the input image 400, and the width and height of the downscaled image can be 256×160. However, the present disclosure is not limited to the aforementioned embodiment, which serves merely as an illustrative example of one implementation of the present disclosure. In other embodiments, the width and height of the downscaled image can be set to other suitable values depending on actual requirements.

In step 920, performing a depth estimation to the downscaled image. In step 930, generating a depth image. For example, the present disclosure may use a neural network to perform the depth estimation. In step 940, the present disclosure may normalize the depth image. For example, the present disclosure may use a depth estimation neural network to perform the normalization. A related formula is as follows:

$$DepthMap = \frac{( DepthMap - min ( DepthMap ) )}{max ( DepthMap ) - min ( DepthMap )} \qquad formula 11$$

Referring to formula 11, DepthMap is the depth image. The depth values output by the neural network can range from 0 to FLOAT_MAX. By applying formula 11, these values are normalized to a range from 0 to 255.

Referring to FIG. 4 and FIG. 10, in step 1010, performing a downscaling process to an input image 400 to generate a downscaled image. For example, the present disclosure may use bilinear interpolation to downscale the input image 400, and the width and height of the downscaled image can be 320×180, with the output being the face location (x, y, width, height) in the image. In step 1020, performing a face detection to the downscaled image. In step 1030, generating a face image. For example, the present disclosure may use a neural network to perform the face detection. However, the present disclosure is not limited to the aforementioned embodiment, which serves merely as an illustrative example of one implementation of the present disclosure. In other embodiments, the width and height of the downscaled image can be set to other suitable values depending on actual requirements.

It should be noted that the present disclosure is not limited to the embodiments as shown in FIG. 1 to FIG. 10, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

Technical features of some embodiments of the present disclosure make an improvement to the prior art. The object centering method and the object centering device of the present disclosure can perform the object centering process to the foreground object image or the face image according to the determination result of the foreground object, thereby addressing the issue that errors in the object detection results affect the object centering process.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An object centering method, which is executed by a processor reading at least one command of a memory, comprising:
performing a foreground object segmentation process according to a depth image and a face image to generate a foreground object image;
determining a relation between the foreground object image and a predetermined threshold to generate a determination result; and
performing an object centering process to the foreground object image according to the determination result to generate an object centering image, or performing the object centering process to the face image according to the determination result to generate the object centering image.

2. The object centering method of claim 1, wherein performing the object centering process to the foreground object image according to the determination result to generate the object centering image comprises:
if a proportion of the foreground object image is larger than the predetermined threshold, performing the object centering process to the foreground object image to generate the object centering image.

3. The object centering method of claim 1, wherein performing the object centering process to the face image according to the determination result to generate the object centering image comprises:
if a proportion of the foreground object image is less than the predetermined threshold, performing the object centering process to the face image to generate the object centering image.

4. The object centering method of claim 1, further comprising:
performing a depth estimation to an input image to generate the depth image.

5. The object centering method of claim 4, wherein performing the depth estimation to the input image to generate the depth image comprises:
performing a downscaling process to the input image to generate a downscaled image; and
performing the depth estimation to the downscaled image to generate the depth image.

6. The object centering method of claim 1, further comprising:
performing a face detection to an input image to generate the face image.

7. The object centering method of claim 6, wherein performing the face detection to the input image to generate the face image comprises:
performing a downscaling process to the input image to generate a downscaled image; and
performing the face detection to the downscaled image to generate the face image.

8. The object centering method of claim 1, further comprising:
generating an object depth-of-field image according to the object centering image and the depth image.

9. The object centering method of claim 1, wherein performing the object centering process to the foreground object image according to the determination result to generate the object centering image comprises:
performing a bounding box adjustment to the foreground object image to generate a corrected bounding box; and
performing an image magnification to the corrected bounding box to generate the object centering image.

10. The object centering method of claim 1, wherein performing the object centering process to the face image according to the determination result to generate the object centering image comprises:
performing a bounding box adjustment to the face image to generate a corrected bounding box; and
performing an image magnification to the corrected bounding box to generate the object centering image.

11. An object centering device, comprising:
a memory, configured to store at least one command; and
a processor, configured to read the at least one command to execute following steps:
performing a foreground object segmentation process according to a depth image and a face image to generate a foreground object image;
determining a relation between the foreground object image and a predetermined threshold to generate a determination result; and
performing an object centering process to the foreground object image according to the determination result to generate an object centering image, or performing the object centering process to the face image according to the determination result to generate the object centering image.

12. The object centering device of claim 11, wherein performing the object centering process to the foreground object image according to the determination result to generate the object centering image which is executed by the processor comprises:
if a proportion of the foreground object image is larger than the predetermined threshold, performing the object centering process to the foreground object image to generate the object centering image.

13. The object centering device of claim 11, wherein performing the object centering process to the face image according to the determination result to generate the object centering image which is executed by the processor comprises:
if a proportion of the foreground object image is less than the predetermined threshold, performing the object centering process to the face image to generate the object centering image.

14. The object centering device of claim 11, wherein the processor is further configured to execute following step:
performing a depth estimation to an input image to generate the depth image.

15. The object centering device of claim 14, wherein performing the depth estimation to the input image to generate the depth image which is executed by the processor comprises:
performing a downscaling process to the input image to generate a downscaled image; and
performing the depth estimation to the downscaled image to generate the depth image.

16. The object centering device of claim 11, wherein the processor is further configured to execute following step:
performing a face detection to an input image to generate the face image.

17. The object centering device of claim 16, wherein performing the face detection to the input image to generate the face image which is executed by the processor comprises:
performing a downscaling process to the input image to generate a downscaled image; and
performing the face detection to the downscaled image to generate the face image.

18. The object centering device of claim 11, wherein the processor is further configured to execute following step:
generating an object depth-of-field image according to the object centering image and the depth image.

19. The object centering device of claim 11, wherein performing the object centering process to the foreground object image according to the determination result to generate the object centering image which is executed by the processor comprises:
performing a bounding box adjustment to the foreground object image to generate a corrected bounding box; and
performing an image magnification to the corrected bounding box to generate the object centering image.

20. The object centering device of claim 11, wherein performing the object centering process to the face image according to the determination result to generate the object centering image which is executed by the processor comprises:
performing a bounding box adjustment to the face image to generate a corrected bounding box; and
performing an image magnification to the corrected bounding box to generate the object centering image.
